(19) United States
(12) Patent Application Publication
(10) Pub. No.: US 2016/0262574 A1
(43) Pub. Date: Sep. 15, 2016

(54) Modular Spice Rack

(71) Applicant: Warren Fish, Bucyrus, MO (US)

(72) Inventor: Warren Fish, Bucyrus, MO (US)

(21) Appl. No.: 15/067,315

(22) Filed: Mar. 11, 2016

Related U.S. Application Data
(60) Provisional application No. 62/131,277, filed on Mar. 11, 2015.

(51) Int. Cl. A47J 47/16; A47J 47/04; B65D 43/02

(52) U.S. Cl. CPC A47J 47/16; B65D 43/0231; B65D 43/0222; A47J 47/04

(57) ABSTRACT

A modular spice rack. The modular spice rack includes a base having an upper side securable to the underside of a kitchen cabinet via one or more fasteners. The base further includes a lower side having plurality of channels disposed thereon. A plurality of containers are removably securable to the base. Each container includes a top portion having a projection disposed thereon. The container projection is configured to slidably engage with the channel, allowing the containers to hang from the base. The container further includes an upper opening for inserting spices and other materials into the container. A lower portion of the container includes a dispensing mechanism for dispensing spices and other materials held within the container. The modular spice rack allows users to arrange spices according to personal preference and provides for easy access to spices during cooking.

### CROSS REFERENCE TO RELATED APPLICATIONS

This application claims the benefit of U.S. Provisional Application No. 62/131,277 filed on Mar. 11, 2015. The above identified patent application is herein incorporated by reference in its entirety to provide continuity of disclosure.

### BACKGROUND OF THE INVENTION

The present invention relates to spice rack systems. More specifically, the present invention relates to spice rack systems that are mountable underneath a cabinet and have multiple removable spice containers.

Many individuals utilize a wide variety of spices when cooking and preparing food. Spices are often sold in small individual containers. Individuals often end up storing multiple small spice containers scattered about in a kitchen drawer. It can be difficult to locate spices during cooking, which can cause complications when spices must be introduced at particular times in order to provide the best flavor. Further, the small spice containers take up space that may otherwise be used for storing other kitchen items such as cooking utensils. Therefore, it is desirable to provide a system for storing multiple spice containers in a convenient and accessible location.

Spice racks for storing multiple spice containers are known. However, common spice racks suffer from multiple drawbacks. Spice racks are typically a unitary structure that rests on a countertop. These spice racks are often obstacles for individuals when cooking and must be navigated around to avoid potential spills. Other spice racks do not allow for the customization of the number of spice containers and the order in which each container is stored, let alone provide for the dispensing of spices when the containers are stored in the spice rack. Chefs and other individuals would benefit greatly from the ability to store spices in an easily accessible location in the preferred order to allow for faster and more efficient cooking. It is therefore desirable to provide a modular spice rack that is mountable to the underside of a kitchen cabinet, so that counter space is saved and individuals are provided with easily accessible spice containers.

### SUMMARY OF THE INVENTION

In view of the foregoing disadvantages inherent in the known types of spice racks now present in the prior art, the present invention provides a modular wherein the same can be utilized for providing convenience for the user when arrange spices for storage and accessing the stored spices during food preparation. The present system comprises a modular spice rack having a base and a plurality of containers securable to the base. The base includes a first end and a second end opposing the first end. One or more mounting apertures are disposed on the first and second end of the base, and one or more fasteners are insertable through the mounting apertures in order to secure an upper portion of the base to a downward facing horizontal surface such as the underside of a kitchen cabinet. A plurality of channels are disposed on a lower portion of the base. The modular spice rack further includes one or more containers, each having a sidewalls extending from a lower interior surface defining an interior volume, and an upper opening disposed on the container for accessing the interior volume and storing spices or other materials therein. The upper container includes a projection disposed thereon, and the projection is configured to slidably engage with the channel on the base. This allows the containers to be mounted to the underside of a kitchen cabinet in order to provide convenient access to spices without reducing counter space.

One object of the present invention is to provide a modular spice rack having none of the disadvantages of prior art spice racks.

Another object of the present invention is to provide a modular spice rack having a dispensing mechanism disposed on a lower portion of the container configured to dispense spices therefrom.

A further object of the present invention is to provide a modular spice rack that allows multiple containers to be removably secured to the underside of a cabinet in any order according to user preference.

Yet another object of the present invention is to provide a modular spice rack having containers with projections having trapezoidal cross-sections.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a modular spice rack according to the present invention.

FIG. 2 shows an exploded view of a modular spice rack according to the present invention.

FIG. 3 shows a perspective view of the dispensing mechanism of a modular spice rack according to the present invention.

### DETAILED DESCRIPTION OF THE INVENTION

Reference is made herein to the attached drawings. Like reference numerals are used throughout the drawings to depict like or similar elements of the modular spice rack. For the purposes of presenting a brief and clear description of the present invention, the preferred embodiment will be discussed as used for storing spices in containers removably secured to the underside of a cabinets. The figures are intended for representative purposes only and should not be considered to be limiting in any respect.

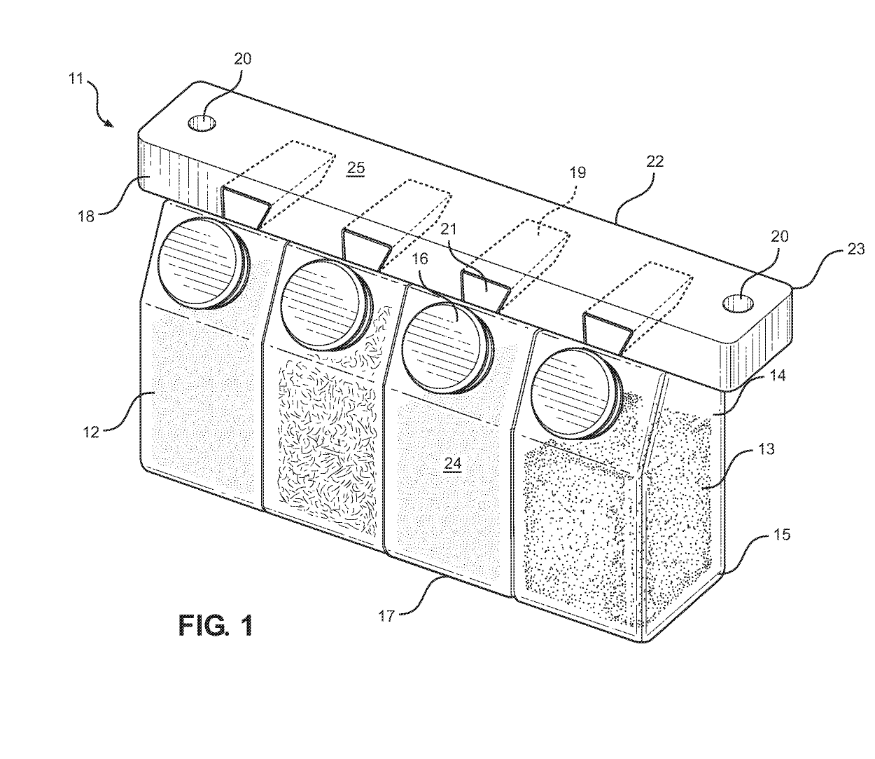

Referring now to FIG. 1, there is shown a perspective view of a modular spice rack according to the present invention. The modular spice rack 11 generally comprises a base 18 configured to support a plurality of containers 12. The base 18 has mounting apertures 20 disposed on opposing sides thereof. The mounting apertures 20 allow the base 18 to be secured to the underside of a cabinet such that a top surface 25 of the base 18 contacts the underside cabinet. The base 18 may be mounted under a cabinet in a general vicinity of a cooking area such as a stove or food prep countertop. This allows users to easily access the containers 12 secured to the base 18 during cooking.

The base 18 further comprises channels 19 disposed through a lower portion of thereof. The channels 19 may extend from a front portion of the base to a rear portion of the base, or alternatively may extend from a front portion of the base and terminate before reaching the rear portion. Each of the containers 12 have a projection 21 disposed on an upper end 14 thereof. The projection 21 is configured to slidably engage with the channel 19 on the base 18. The container 12 further comprises peripheral sidewalls 15 that define an interior volume 13. The interior volume 13 is configured to store spices therein and is accessible through an opening disposed on the front surface 24 of the container 12. A lid 16 is disposed over the opening and may be secured thereto via a friction fit or threaded connection. The lid 16 may remain on the container 12 continuously in order to keep spices therein fresh, and may be removed to add additional or new spices to the interior volume 13 of the container 12.

The lower edges 17 of each container 12 align with one another to form a continuous lower edge 17 along the lower portion of each container 12. Each container 12 is adjacent to another container 12 when secured within the base 18. This configuration utilizes all available space and allows multiple containers 12 to be secured to the base 18 while still keeping the modular spice rack 11 compact so that it may fit in small spaces underneath a cabinet. In the illustrated embodiment, the base 18 further comprises a rectangular perimeter 22. The rectangular perimeter 22 comprises rounded corners 23 in order to prevent an individual from accidentally injuring their hands when reaching for a container 12 secured to the base 18.

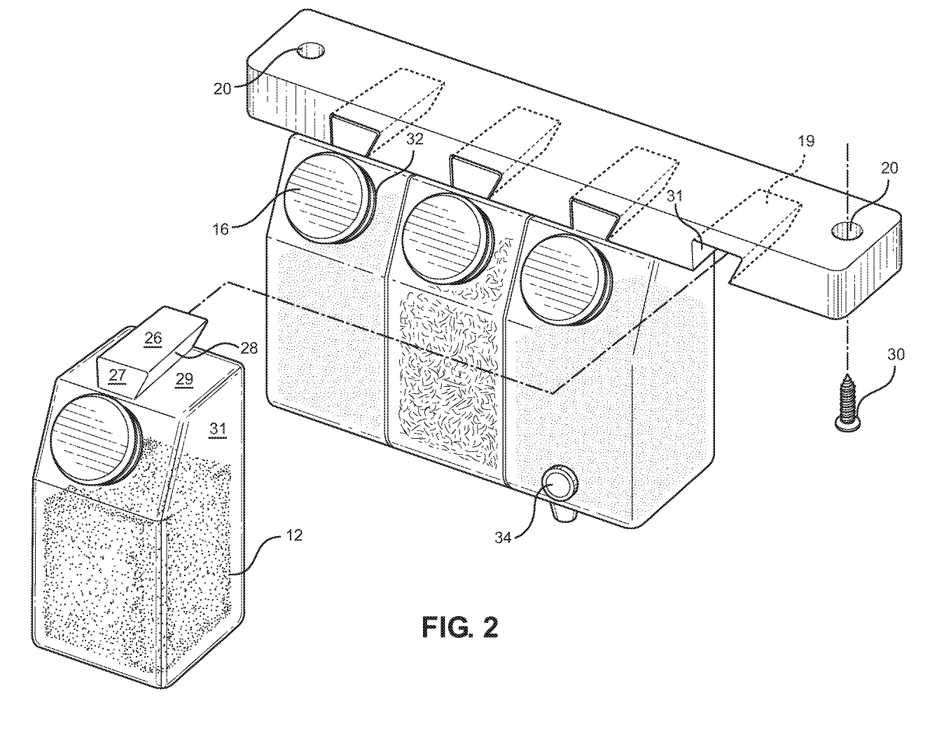

Referring now to FIG. 2, an exploded view of a modular spice rack according to the present invention is shown. Each of the containers 12 may be independently removed from the base 18 so that the user may utilize as many containers 12 as desired and organize them in a convenient manner. In the illustrated embodiment, the projection includes opposing sides 28 that extend upwardly from the upper surface 29 of the container 12. The opposing sides 28 taper outwardly, creating a dovetail shape and defining a trapezoidal cross-section of the projection. The top surface 26 and opposing sides 28 slidably engage with the interior surface 31 of the channel 19. In other embodiments, other shapes for the projection may be utilized, such as a T-shaped projection. However, the trapezoidal cross-section provides effective securement of the container 12 to the base 18. The front surface 27 of the projection is preferably flush with the front surface of the base 18 when secured in the channel 19, which saves additional space and provides a pleasing aesthetic appearance.

The base 18 may be mounted to the underside of a cabinet via fasteners 30 that are insertable through the apertures 20. The fasteners 30 may be screws, nails, magnetic fasteners, or any other fasteners capable of securing the base 18 to the underside of a cabinet. Further, the upper container opening may comprise a threaded lip 32 so that the lid 16 may be secured thereto via a threaded connection. Users may remove the lid 16 in order to fill the containers 12 with spices or other desired materials. A dispensing mechanism 42 is disposed on the lower end of the container 12. The dispensing mechanism 34 allows users to dispense desired quantities of spices from the container 12 when it is secured to the base 18.

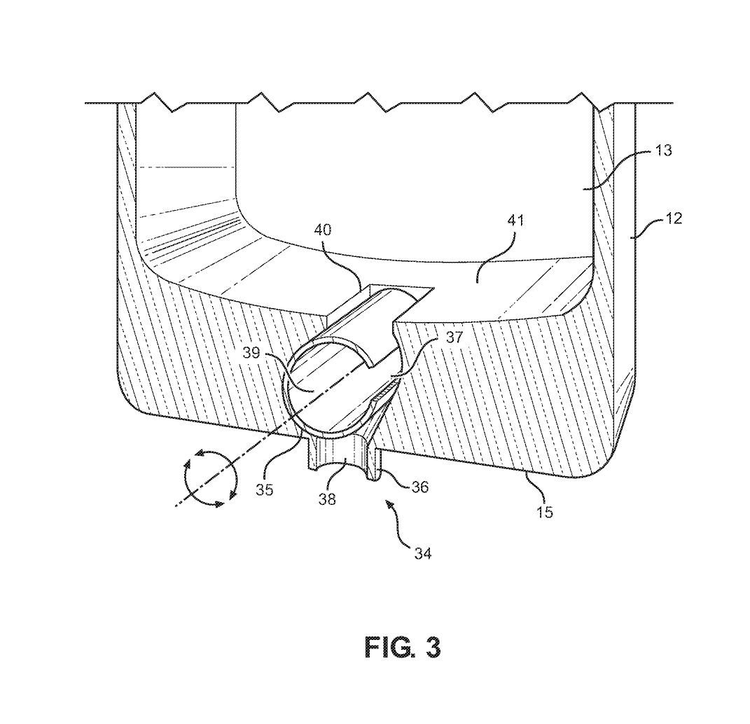

Referring now to FIG. 3, there is shown a perspective view of the dispensing mechanism of a modular spice rack according to the present invention. The container 12 further comprises a dispenser opening 40 disposed on an interior surface 41 of the container 12. A rotating cylinder 35 is rotatably disposed within the dispenser opening 40. The rotating cylinder 35 has a volume 39 and a cylinder opening 37 disposed thereon for accessing the volume 39. A dispensing tube 36 extends downward from the lower portion 15 of the container 12. The dispensing tube 36 comprises a dispensing channel 38.

The container 12 stores spices within the interior volume 13. In order to dispense spices from the dispensing mechanism 34, a user rotates the cylinder 35 until the cylinder opening 27 aligns with the dispenser opening 40. Spice or other stored material then flows from the interior volume 13 of the container 12 to the volume 39 of the cylinder. The user then continues to rotate the cylinder 35 in the same direction, until the cylinder opening 27 aligns with the dispensing channel 38 of the dispensing tube 36. The material in the volume 39 of the cylinder 35 then falls through the dispensing channel 38. Users may then collect the material in a secondary container such as a measuring cup or spoon. If the user wishes to dispense a small amount of spice, the user may rotate the cylinder 35 until the cylinder opening 27 is only partially aligned with the dispensing channel 38, allowing a smaller amount of spice to be dispensed. Alternatively, complete alignment between the cylinder opening 27 and the dispenser channel 38 allows a large amount of spice to be dispensed, which is useful for users who wish to utilize large quantities of a particular spice at once.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A modular spice rack, comprising:
a base comprising a first end and a second end opposing the first end;
one or more mounting apertures disposed on the first end and second end of the base;
one or more fasteners insertable through the mounting apertures and configured to secure an upper portion of the base to a downward-facing horizontal surface;
a plurality of channels disposed on a lower portion of the base;
a container having sidewalls extending from a lower interior surface defining an interior volume;
an upper opening disposed on the container for accessing the interior volume;
wherein an upper end of the container comprises a projection disposed thereon; and
wherein the container projection is configured to slidably engage with one of the plurality of channels.

2) The modular spice rack of claim 1, further comprising a dispensing mechanism, the dispensing mechanism comprising:
a dispenser opening disposed on a lower interior surface of the interior volume of the container;
a rotating cylinder having an open portion rotatably disposed within the dispenser opening;
a dispensing tube disposed on a lower portion of the container below the rotating cylinder;
wherein the rotating cylinder is configured to rotate and dispense material received from the interior volume of the container through the open portion of the rotating cylinder and the dispensing tube.

3) The modular spice rack of claim 1, wherein the container projection comprises:
a front surface;
a top surface configured to contact an inner edge of one of the plurality of channels;
opposing sidewalls extending vertically from an upper surface of the container, wherein the sidewalls taper outwardly toward opposing sides of the container; and
wherein the projection further comprises a trapezoidal cross-section.

4) The modular spice rack of claim 3, wherein the front surface of the container projection is flush with a front surface of the base when the projection is slidably disposed within one of the plurality of channels.

5) The modular spice rack of claim 1, further comprising:
a lid removably secured to the container over the upper opening of the container.

6) The modular spice rack of claim 1, wherein the opening comprises a threaded lip, and wherein the lid is removably secured to the container via a threaded connection with the threaded lip.

7) The modular spice rack of claim 1, wherein the opening comprises a smooth lip, and wherein the lid is removably secured to the container via a friction fit over the smooth lip.

8) The modular spice rack of claim 1, wherein the base comprises a rectangular perimeter.

9) The modular spice rack of claim 7, wherein the rectangular perimeter comprises one or more rounded corner edges.

10) The modular spice rack of claim 1, wherein the container projection is securable within one of the plurality of channels via a friction fit therewith.
